(19) United States
(12) Patent Application Publication
(10) Pub. No.: US 2009/0243414 A1
(43) Pub. Date: Oct. 1, 2009

(54) MAGNETIC MOTOR

(76) Inventor: Alfredo Messina Lamas, La Coruna (ES)

Correspondence Address: DARBY & DARBY P.C., P.O. BOX 770, Church Street Station, New York, NY, 10008-0770, US

(21) Appl. No.: 12/414,218

(22) Filed: Mar. 30, 2009

(30) Foreign Application Priority Data
Mar. 29, 2008 (ES) PCT/ES2008/070061

(51) Int. Cl. H02K 21/02; H02N 11/00

(52) U.S. Cl. 310/152; 415/916

(57) ABSTRACT

The present invention relates to the field of electric motors, and more particularly to a motor driven by permanent magnets. The magnetic motor of the invention comprises a main rotor and auxiliary rotors, as well as a plurality of novel magnetic barriers allowing the magnets to actuate only when the direction of the force created by said magnets is coincident with the movement.

### FIELD OF THE INVENTION

Priority is claimed to International Patent Application PCT/ES2008/070061 filed on Mar. 29, 2008, the entire disclosure of which is incorporated by reference herein.

The present invention relates to the field of electric motors, and more particularly to a motor driven by permanent magnets. The magnetic motor of the invention comprises a main rotor and auxiliary rotors, as well as a plurality of novel magnetic barriers allowing the magnets to actuate only when the direction of the force created by said magnets is coincident with the movement

### BACKGROUND OF THE INVENTION

There are many types of motors, such as motors consuming electricity, gas, petroleum products, etc. Nevertheless, one way or the other, all of them cause the emission of pollution to the atmosphere. A known solution to this problem has been the use of magnetic motors which, in addition to the force provided by permanent magnets, may employ either DC current, AC current, or no current at all. These motors usually comprise permanent magnets attached to a rotor, the force generated by the permanent magnets causing said rotor to turn. Nevertheless, the repulsion force contrary to the movement of the rotor created by the magnets cancels the repulsion force required to get to that point, this feature in turn causing the torque created by the latter to be usually too weak for its use in industrial applications.

The novel magnetic motor described in the present application will substitute for prior pollution-producing motors, being suitable for its use in a wide range of fields, such as industrial, automotive, naval, voltage generation in power plants, etc.

### SUMMARY OF THE INVENTION

In order to solve the abovementioned problem, the magnetic motor of the invention comprises:
A main rotor comprising a plurality of permanent magnets distributed along its periphery, the arrangement of the magnets being such that one pole faces the exterior of the main rotor and the other pole faces the interior of the main rotor. The magnets may all have the same pole facing the exterior of the main rotor, although it's also possible that they be arranged alternatively.

Also, the magnets may be arranged in a fixed position facing the center of main rotor, or else they may form an angle relative to that direction. In such case, they may be pivotally fixed to the main rotor.

The size of the magnets is variable depending on the turn ratio between the main rotor and the auxiliary rotor, since the auxiliary rotors complete as many complete turns for each turn of the main rotor as the number of magnets of the same polarity arranged in the main rotor.

Further, the magnets may be comprised of a magnetic strip.
A plurality of auxiliary rotors distributed around the main rotor, each auxiliary rotor further comprising a magnet having the poles arranged such that rotation of the auxiliary rotors causes their north and south poles to alternatively face the main rotor; and
A plurality of magnetic barriers, distributed around the main rotor between each pair of auxiliary rotors, the magnetic barriers being arranged such that they impede the interaction of the magnets of the main rotor with the magnets of the auxiliary rotors when the resultant force is contrary to the movement.

The magnetic barriers prevent the force generated by the magnets of the main rotor to be applied to the auxiliary rotors while such force is contrary to the movement. Once the force starts to be favourable to the movement, the magnets of the main rotor start to be visible through the space between the magnetic barriers and act on the auxiliary rotors, causing them to turn. As soon as this force starts to be negative again, the magnets of the main rotor are again hidden behind the magnetic barriers, thus not acting on the auxiliary rotors. The magnetic barriers may also avoid interaction between the magnets of the auxiliary rotors, in order to “block” any force which could act against the movement. In short, the distribution of the magnets and the magnetic barriers is such that negative forces are compensated by positive forces in order to cancel forces contrary to the movement.

The invention may also comprise additional devices for starting or stopping the magnetic motor, as well as for accelerating or braking the same. These devices for accelerating or braking the magnetic motor may cause the displacement of the auxiliary rotors closer to or farther from the main rotor, or else they may cause the magnets of the main rotor to pivot or turn. An exemplary device could cause a phase displacement of the main rotor with respect to the auxiliary rotors, the turning force of the auxiliary rotors gradually diminishing until it opposes the movement, thus acting as a brake. Also, depending on the type of magnetic motor, it may be necessary to employ an additional conventional starting motor, since when the magnetic motor stops the force may oppose the movement. Nevertheless, once it is turning, each force is canceled by a corresponding one, the result being that the positive forces are greater than the negative forces.

Another embodiment is directed to a motor having auxiliary rotors fixed to the main rotor, while the magnets are located in fixed spots around the main rotor.

Another embodiment of the invention could employ gear teeth for connecting the auxiliary rotors to the magnets of the main rotor, in which case the starting-stopping of the motor could not be made by means of a phase displacement between the main rotor and the auxiliary rotors.

All magnets of the invention may be manufactured in any type of magnetic material, including ferrite, alnico, rare earths, etc.

### BRIEF DESCRIPTION OF THE DRAWINGS

FIG. 1 shows a perspective view of a first embodiment of the magnetic motor of the invention.

FIG. 2 shows a cross section of the magnetic motor of FIG. 1.

FIG. 3 shows a detailed view of a magnetic barrier according to the invention.

FIG. 4 shows a detailed view of an auxiliary rotor according to the invention.

FIG. 5 shows a second embodiment of the invention where the auxiliary rotors are connected to the main rotor by means of gear teeth.

### DESCRIPTION OF PREFERRED EMBODIMENTS

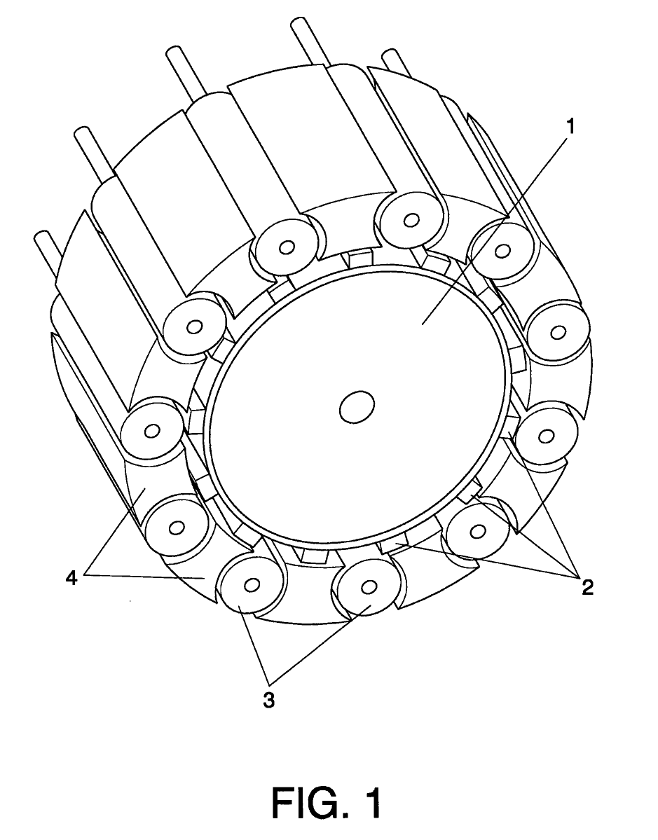

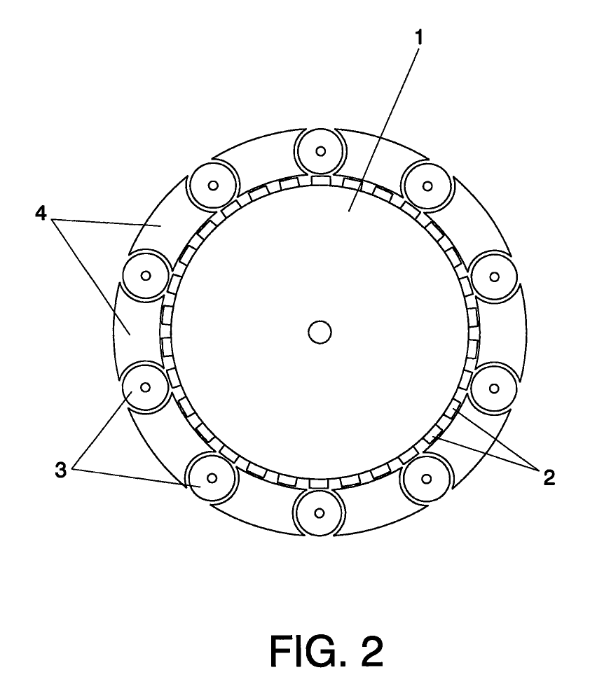

FIGS. 1 and 2 show a main rotor (1) having magnets (2) fixed to the periphery of the main rotor (1). Auxiliary rotors (3) are distributed around the main rotor (1), magnetic barriers (4) being provided between each pair of auxiliary rotors (3).

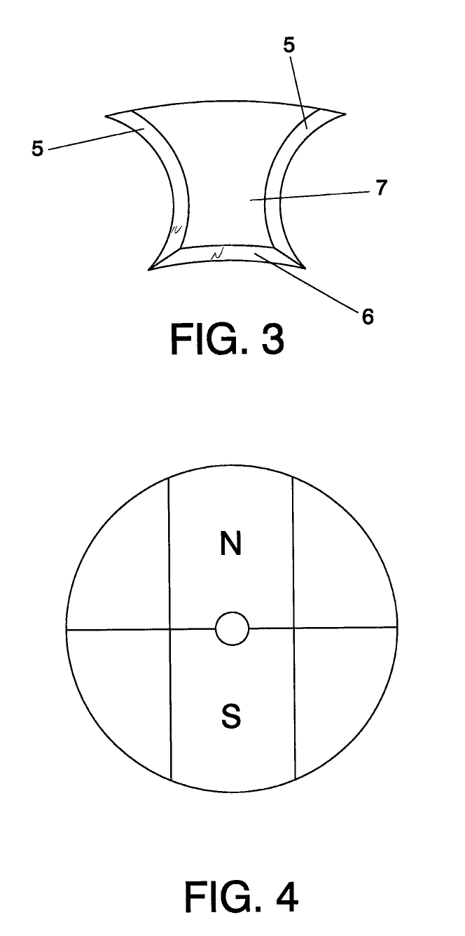

FIG. 3 shows a more detailed example of a magnetic barrier (4) having lateral magnetic strips (5) facing the auxiliary rotors (3). Also, a front magnetic strip (6) faces the main rotor (1). The magnetic barrier has a central part (7) which is formed by a material allowing a good separation of the forces, such as a magnetic material, materials being affected by magnetic fields, materials not affected by magnetic fields. The central part (7) may also comprise a combination of various types of materials. On the other hand, FIG. 4 shows an example of auxiliary rotor (3) having a magnet arranged in a central strip such that rotation of the auxiliary rotor (3) causes the north and south poles to alternatively face the main rotor (1). The auxiliary rotor (3) may also be completely made of a magnetic material.

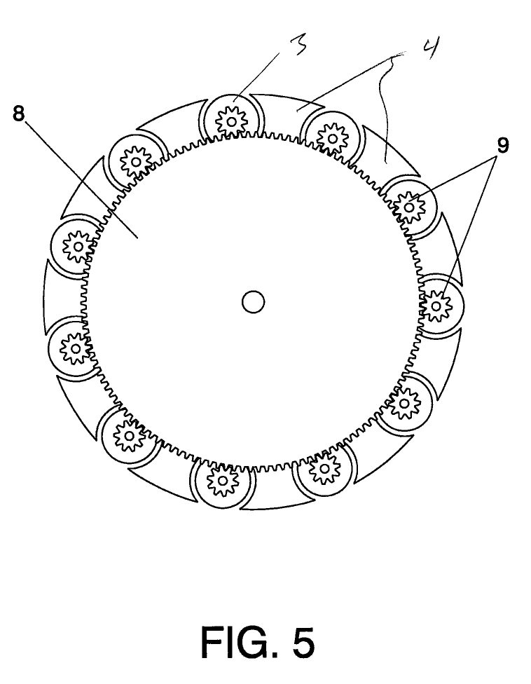

FIG. 5 shows a second embodiment of the invention which, as in the embodiment of FIG. 1 includes a main rotor (1) comprises a plurality of permanent magnets (2), all of which are oriented such that their north pole faces the exterior of the main rotor (1). A plurality of auxiliary rotors (3) distributed around the main rotor (1) have auxiliary gear wheels (9) which are connected to a main gear wheel (8) of the main rotor (1). The teeth ratio between the auxiliary gear wheels (9) and the main gear wheel (8) may be variable in order to control the starting, stop, acceleration or braking of the motor.

Both the embodiments of FIG. 1 and FIG. 5 include magnetic barriers (4) between each pair of auxiliary rotors (3) for impeding the interaction of the magnets (2) of the main rotor (1) with the magnets of the auxiliary rotors (3) when the resultant force is contrary to the movement. These barriers (4) have a shape that “wraps” around the sides of the adjacent auxiliary rotors (3) and also the main rotor (1). Each barrier (4) comprises lateral magnetic strips (5) at the sides facing the adjacent auxiliary rotors (3) and a front magnetic strip (6) at the side facing the main rotor (1). The width of the magnetic strips (5, 6) depends on the magnetic properties of the material they are made of, having their north pole facing, for example, the rotors (1, 3). The central part (7) of the magnetic barrier (4) may be made of a combination of materials, such as iron or other materials having a greater magnetic absorption value, or alternatively materials not affected by magnetic fields. This way, since the magnetic barrier (4) has firstly a magnetic strip (5, 6) comprised of a magnet and then a material absorbing the magnetic field, it impedes the interaction between magnets having such magnetic barrier (4) in between, such as the magnets (2) of the main rotor (1) and the magnets of the auxiliary rotors (3).

Thus, the north pole of the strips (5) of the magnetic barriers (4) is located at both sides of the auxiliary rotors (3). Thus, since the south pole of the magnet of the rotor (3) tries to face the north pole of the lateral strip (5) of the magnetic barrier (4) and, at the same time, the north pole of the auxiliary rotor (3) tries to face away from the north pole of the lateral strip (5) of the barrier (4) located on the other side, the forces cancel, rendering almost no resulting force. On the other hand, the magnets (2) of the main rotor (1), as their north poles get closer to the north pole of the front magnetic strip (6) of the magnetic barrier (4), experience a force contrary to the movement. Nevertheless, by choosing a correct number of magnets having alternating polarity, while from one side a force contrary to movement is present, from the other side a magnet (2) having the opposite polarity receives a favourable force which cancels the opposite force from the other magnet (2), and, once the center of the magnetic barrier (4) is reached, the magnet (2) starts experimenting a positive force equal to the negative force it experimented when approaching the magnetic barrier (4), and thus the forces cancel. At the same time a magnet (2) is getting closer to a magnetic barrier (4), at a different place another magnet (2) is getting away from another barrier (4), the forces being thus compensated. In order to better distribute the forces, the correct number of magnets must be chosen, both in the auxiliary rotors (3) and in the main rotor (1). The only force left is that of the auxiliary rotor (3), which, when the magnet (2) of the main rotor (1) gets away from the magnetic barrier (4), the magnet of the the auxiliary rotor (3) has its north pole facing the magnet (2) of the main rotor (1), which forces the auxiliary rotor (3) to turn around its axis of rotation in order to move its north pole away from the north pole of the magnet (2) of the main rotor (1) and get its south pole closer to the north pole of the magnet (2) of the main rotor (1). The rotation force of the auxiliary rotor (3) at that point is greater than the repulsion force acting on the magnet (2) of the main rotor (1), and when the south pole of the magnet of the auxiliary rotor (3) is almost facing the north pole of the magnet (2) of the main rotor (1), the magnet (2) of the main rotor (1) “hides” behind another magnetic barrier (4) because the resultant force starts to be negative.

1. A magnetic motor comprising:
a main rotor including a plurality of magnets distributed around a periphery of said main rotor, said plurality of magnets being arranged such that a first pole of each magnet faces an exterior of the main rotor while a second pole of each magnet faces an interior of the main rotor;
a plurality of auxiliary rotors distributed around the main rotor, the plurality of auxiliary rotors including an auxiliary rotor magnet arranged such that rotation of the auxiliary rotors causes a north pole and a south poles of each auxiliary rotor magnet to alternatively face the main rotor; and
a plurality of magnetic barriers distributed around the main rotor between pairs of auxiliary rotors, said magnetic barriers configured to impede an interaction of the magnets of the main rotor with the auxiliary rotor magnets when a resultant force is contrary to the rotation of a respective auxiliary rotor.

2. The magnetic motor according to claim 1, wherein the magnetic barriers comprise lateral magnetic strips at a side adjacent to the auxiliary rotors (3) and a front magnetic strip at a side adjacent to the main rotor.

3. The magnetic motor according to claim 1, wherein the magnets of the main rotor face a center of the main rotor.

4. The magnetic motor according to claim 1, wherein the magnets of the main rotor form an angle with respect to a direction passing through a center of the main rotor.

5. The magnetic motor according to claim 1, wherein each magnet of the main rotor has a same pole facing outside the main rotor.

6. The magnetic motor according to claim 1, wherein poles of the magnets of the main rotor alternatively face towards an inside and towards an outside of the main rotor.
